(19) United States
(12) Patent Application Publication
(10) Pub. No.: US 2010/0164851 A1
(43) Pub. Date: Jul. 1, 2010

(54) LIQUID CRYSTAL DISPLAY AND PIXEL UNIT THEREOF

(76) Inventors: Wen-Chun Wang, Taichung City (TW); Chien-Ging Chan, Chang Hua County (TW)

Correspondence Address: Muncy, Geissler, Olds & Lowe, PLLC, 4000 Legato Road, Suite 310, FAIRFAX, VA, 22033, US

(21) Appl. No.: 12/647,303

(22) Filed: Dec. 24, 2009

(30) Foreign Application Priority Data
Dec. 26, 2008 (TW) 097150779

(51) Int. Cl. G09G 3/36

(52) U.S. Cl. 345/98

(57) ABSTRACT

One embodiment of the invention is to provide a pixel unit coupled to a data line, a first scan line, and a second scan line. The pixel unit comprises a first sub-pixel unit and a second sub-pixel unit. The first sub-pixel unit comprises a first switching device coupled to the data line, a first storage capacitor and a first liquid crystal capacitor coupled to the first switching device. The second sub-pixel unit comprises a second switching device coupled to the first switching device, a coupling capacitor, and a second storage capacitor and a second liquid crystal capacitor coupled to the second switching device. The coupling capacitor is coupled between the first and second input/output terminals of the second switching device. The control terminal of the first switching device is coupled to the first scan line. The control terminal of the second switching device is coupled to the second scan line.

### BACKGROUND OF THE INVENTION

(a) Field of the Invention

The invention relates to a liquid crystal display and pixel units thereof, particularly to a liquid crystal display and pixel units thereof where different areas in a pixel unit have their respective characteristic V-T curve.

(b) Description of the Related Art

FIG. 1 shows an equivalent circuit diagram for a pixel unit of a liquid crystal display (LCD). Referring to FIG. 1, a pixel unit 110 of an LCD 101 has a first sub-pixel unit 111 and a second sub-pixel unit 112. According to a conventional design, two thin film transistors T1 and T2 are used to respectively control voltage change of the first sub-pixel unit 111 and the second sub-pixel unit 112, so that the first pixel unit 111 and the second pixel unit 112 may implement correction for their respective gamma curves to have competent optical matching.

FIG. 2 shows a schematic diagram illustrating drive architecture for the LCD shown in FIG. 1. Referring to FIG. 2, the drive architecture 100 includes a thin film transistor array 102, a first image signal drive circuit 104, a second image signal drive circuit 106, and a scan signal drive circuit 108. Referring to both FIG. 1 and FIG. 2, the scan signal drive circuit 108 that generates scan signals is coupled to the gate of each thin film transistor through row electrodes G1A-G4A. The first image signal drive circuit 104 sequentially generates image signals that correspond to each scan signal, and the image signals are transmitted to the first sub-pixel unit 111 through column electrodes D1A-D4A and the thin film transistor corresponding to the first sub-pixel unit 111 (such as thin film transistor T1). The second image signal drive circuit 106 sequentially generates image signals that correspond to each scan signal, and the image signals are transmitted to the second sub-pixel unit 112 through column electrodes D1B-D4B and the thin film transistor corresponding to the second sub-pixel unit 112 (such as thin film transistor T2).

Though, in the conventional design, two thin film transistors T1 and T2 respectively control the voltage change of the first sub-pixel unit 111 and the second sub-pixel unit 112 to allow for competent optical matching in a single-cell-gap LCD, it requires complicated circuitry to implement the correction for gamma curves. For example, two image signals drive circuits 104 and 106 and double column electrodes are needed as shown in FIG. 2. This considerably increases the fabrication cost and design complexity.

### BRIEF SUMMARY OF THE INVENTION

In light of the above problems, one objective of an embodiment of the invention is to provide a liquid crystal display and pixel units thereof where different areas in a pixel unit have their respective characteristic V-T curves. As a result, the liquid crystal display and pixel units according to an embodiment of the present may have an advantage of simplifying the drive architecture and low fabrication cost thereof, or allowing competent optical matching.

One embodiment of the invention is to provide a pixel unit coupled to a data line, a first scan line and a second scan line. The pixel unit comprises a first sub-pixel unit and a second sub-pixel unit. The first sub-pixel unit comprises a first switching device coupled to the data line, a first storage capacitor and a first liquid crystal capacitor coupled to the first switching device. The second sub-pixel unit comprises a second switching device coupled to the first switching device, a coupling capacitor, and a second storage capacitor and a second liquid crystal capacitor coupled to the second switching device. The coupling capacitor is coupled between a first input/output terminal and a second input/output terminal of the second switching device. A control terminal of the first switching device is coupled to the first scan line, and a control terminal of the second switching device is coupled to the second scan line.

One embodiment of the invention is to provide a liquid crystal display comprises a plurality of scan lines and a plurality of data lines defining a plurality of pixel units mentioned above.

According to one embodiment, in the above liquid crystal display and the above pixel unit, the scan line to which the first switching device is coupled is adjacent to the scan line to which the second switching device is coupled. It is preferred that the scan lines may be respectively an n^{th} scan line and an (n-1)^{th} scan line.

One embodiment of the invention is to provide a pixel unit comprises a first sub-pixel unit, a second sub-pixel unit and a bi-directional diode. The first sub-pixel unit comprises a first switching device, a first storage capacitor and a first liquid crystal capacitor coupled to the first switching device. The second sub-pixel unit comprises a second storage capacitor and a second liquid crystal capacitor coupled to each other. The bi-directional diode is coupled between the first liquid crystal capacitor and the second liquid crystal capacitor. It is preferred that the bi-directional diode is coupled between the first sub-pixel electrode and the second sub-pixel electrode. In one embodiment, the bi-directional diode includes a first diode and a second diode. A first end of the first diode is coupled to a second end of the second diode. A second end of the first diode is coupled to a first end of the second diode. A third end of the first diode is coupled to a first end of the first diode. A third end of the second diode is coupled to a first end of the second diode. Accordingly, a first parasitic capacitor is formed between the second end and the third end of the first diode; a second parasitic capacitor is formed between the second end and the third end of the second diode.

According to an embodiment of the present invention, through typical TFT fabrication processes for forming the pixel units, the effect is achieved that a same pixel unit has two distinct characteristic V-T curves.

### BRIEF DESCRIPTION OF THE DRAWINGS

FIG. 1 shows an equivalent circuit diagram for a pixel unit of a liquid crystal display (LCD).

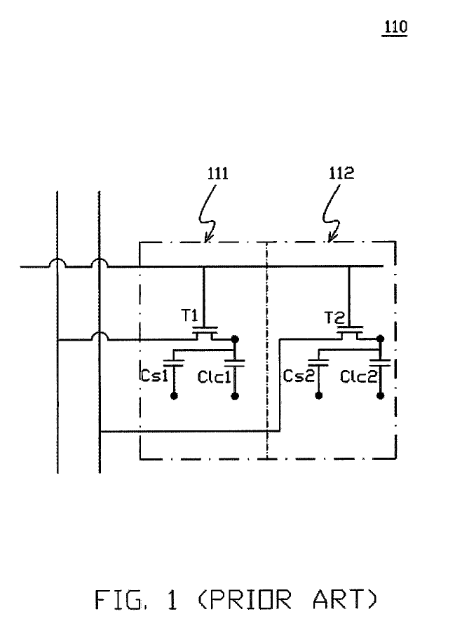

FIG. 2 shows a schematic diagram illustrating drive architecture for the LCD shown in FIG. 1.

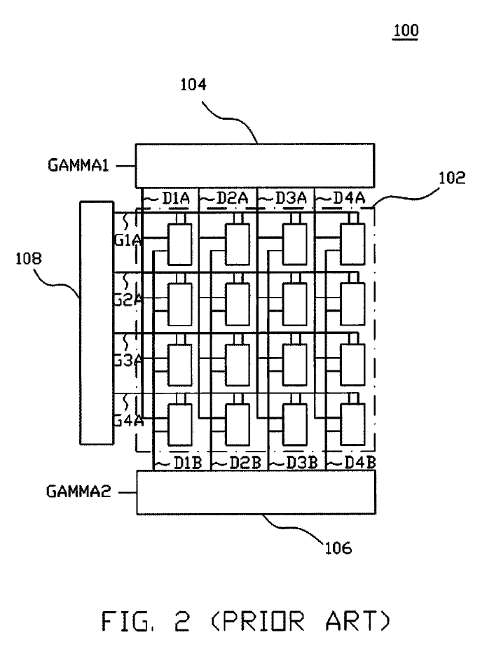

FIG. 3 shows a schematic diagram of a liquid crystal display (LCD) according to an embodiment of the invention.

FIG. 4 shows an equivalent circuit diagram of the LCD in FIG. 3.

FIG. 5 shows an equivalent circuit diagram for a pixel unit of a liquid crystal display (LCD).

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and variations thereof herein are used broadly and encompass direct and indirect connections, couplings, and mountings. Similarly, “adjacent to” and variations thereof herein are used broadly and encompass directly and indirectly “adjacent to”. Therefore, the description of “A” component “adjacent to” “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

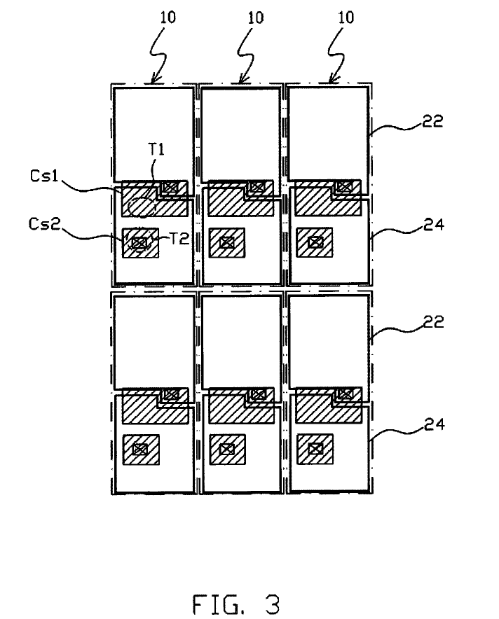

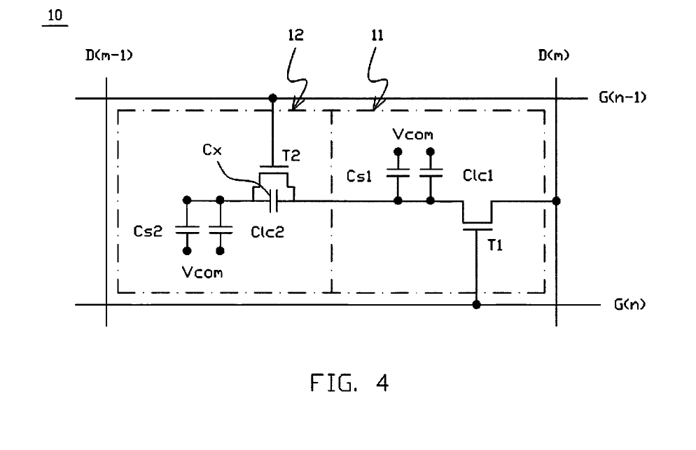

FIG. 3 shows a schematic diagram of a liquid crystal display (LCD) according to an embodiment of the invention. FIG. 4 shows an equivalent circuit diagram of the LCD in FIG. 3. Referring to both FIG. 3 and FIG. 4, in this embodiment, a LCD includes a plurality of pixel units 10, a plurality of scan lines G, a plurality of data lines D, a common electrode (not shown) and a liquid crystal layer(not shown). Each pixel unit 10 includes a first thin film transistor T1, a second thin film transistor T2, a first sub-pixel electrode 22 and a second sub-pixel electrode 24. Each pixel unit 10 may be for example a red (R) pixel, a green (G) pixel and a blue (B) pixel.

The pixel unit 10 may be divided into a first sub-pixel unit 11 and a second sub-pixel unit 12. A thin film transistor T1, a storage capacitor Cs1, and a liquid crystal capacitor Clc1 is formed in the first sub-pixel unit 11. The liquid crystal capacitor Clc1 is formed by a first sub-pixel electrode 22 and a common electrode (not shown) that are spaced apart from each other by a liquid crystal layer (not shown), and the storage capacitor Cs1 and the liquid crystal capacitor Clc1 are coupled to the first thin film transistor T1. A second thin film transistor T2, a storage capacitor Cs2, a liquid crystal capacitor Clc2 and a coupling capacitor Cx are formed in the second sub-pixel unit 12. The liquid crystal capacitor Clc2 is formed by a second sub-pixel electrode 24 and a common electrode (not shown) that are spaced apart from each other by a liquid crystal layer (not shown). The storage capacitor Cs2 and the liquid crystal capacitor Clc2 are coupled to the thin film transistor T2. The two ends of the coupling capacitor Cx are coupled to the source and drain of the thin film transistor T2 and then are coupled to the first sub-pixel electrode 22 and the second sub-pixel electrode 24. The gate of the first thin film transistor T1 is coupled to an n^{th} scan line G(n) among the scan lines G; the source of the first thin film transistor T1 is coupled to a m^{th} data line D(m) among the data lines D; the drain of the first thin film transistor T1 is coupled to the source of the thin film transistor T2. The gate of the thin film transistor T2 is coupled to an (n-1)^{th} scan line G(n-1) among the scan lines G which is adjacent to the n^{th} scan line G(n). The (n-1)^{th} scan line G(n-1) is the previous-staged scan line of the n^{th} scan line G(n), that is, the scan signal is inputted into the (n-1)^{th} scan line G(n-1) and then inputted into the n^{th} scan line G(n).

According to the design of this embodiment, the width/length ratio of the second thin film transistor T2 or the capacitance of the coupling capacitor Cx can be adjusted to achieve the effect that a same pixel unit has two distinct characteristic V-T curves, that is, the phase difference between the first sub-pixel electrode 22 of a pixel unit 10 and the common electrode Vcom is different from the phase difference between a second sub-pixel electrode 24 of the same pixel unit 10 and the common electrode Vcom. This technical feature may solve the problem of color shift and image-sticking. This technical feature may also enhance optical performance in different application aspects. For example, in a wide-viewing-angle LCD, the formation of two distinct characteristic V-T curves allows for compensation of viewing-angle. Alternatively, in a transflective LCD, the formation of two distinct characteristic V-T curves may enhance the optical matching of the reflective region and the transmissive region.

Hence, through typical TFT fabrication processes for forming the coupling capacitor Cx, two different voltage differences are obtained that are respectively between a first sub-pixel electrode 22 and the common electrode Vcom and between a second sub-pixel electrode 24 and the common electrode Vcom in a case that two thin film transistors T1 and T2 are coupled to a same data signal source. Compared with the conventional art, the number of the data signal sources may be reduced and the circuit of a pixel structure may be simplified according to an embodiment of the present invention. In addition, competent optical matching may be obtained by the use of typical TFT fabrication processes without additional fabrication cost and complicated drive architecture.

Since the gate of the second thin film transistor T2 is coupled to an (n-1)^{th} scan line G(n-1) and the source and drain of the second thin film transistor T2 are coupled to two ends of the coupling capacitor Cx, the voltage difference between the first sub-pixel electrode 22 and the second sub-pixel electrode 24 may be neutralized by provision of the second thin film transistor T2 when the previous-staged scan line which is the (n-1)^{th} scan line G(n-1) is driven. In addition, the second sub-pixel electrode 24 can discharge electricity through a discharge path formed by the provision of the second thin film transistor T2 when driving the present-staged scan line G(n) is stopped. Accordingly, problem of charge residual (DC residual) may be improved.

Furthermore, the above design may have an advantage that the second sub-pixel electrode 24 is less likely to be subject to the influence of feed-through issue.

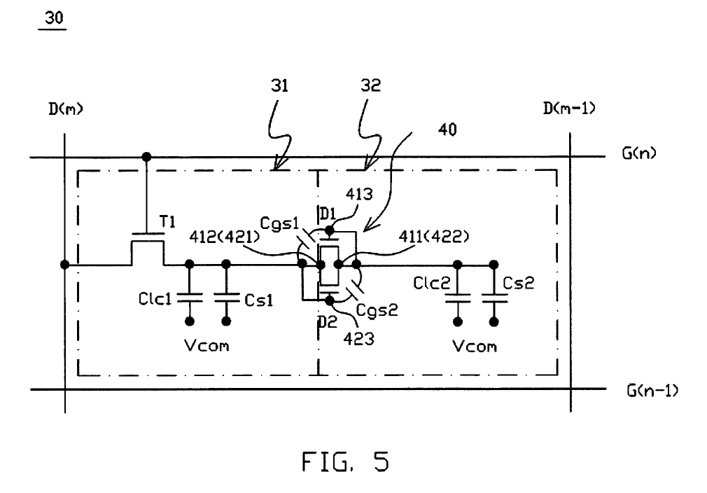

FIG. 5 shows an equivalent circuit diagram for a pixel unit of a liquid crystal display according to an embodiment of the present. The pixel unit 10 is similar to the pixel unit 30, and therefore the same numerical reference designates the same member in these pixel units and the descriptions of the same members will be omitted. Only the difference between these apparatus will be described in the followings.

Referring to FIG. 5, the pixel unit 30 may be divided into a first sub-pixel unit 31 and a second sub-pixel unit 32. A thin film transistor T1, a storage capacitor Cs1, and a liquid crystal capacitor Clc1 is formed in the first sub-pixel unit 31. The liquid crystal capacitor Clc1 is formed by a first sub-pixel electrode (not shown) and a common electrode (not shown) that are spaced apart from each other by a liquid crystal layer (not shown), and the storage capacitor Cs1 and the liquid crystal capacitor Clc1 are coupled to the first thin film transistor T1. The gate of the first thin film transistor T1 is coupled to an n^{th} scan line G(n) among the scan lines G; the source of the first thin film transistor T1 is coupled to a m^{th} data line D(m) among the data lines D; the drain of the first thin film transistor T1 is coupled to the liquid crystal capacitor Clc1. A storage capacitor Cs2 and a liquid crystal capacitor Clc2 which are coupled to each other are formed in the second sub-pixel unit 32. The liquid crystal capacitor Clc2 is formed by a first sub-pixel electrode (not shown) and a common electrode (not shown) that are spaced apart from each other by a liquid crystal layer (not shown). A bi-directional diode 40 is coupled between the liquid crystal capacitor Clc1 and the liquid crystal capacitor Clc2; it is preferred that the bi-directional diode 40 is coupled between the first sub-pixel electrode and the second sub-pixel electrode. The bi-directional diode 40 includes a first diode D1 and a second diode D2. The first end 411 of the first diode D1 is coupled to the second end 422 of the second diode D2. The second end 412 of the first diode D1 is coupled to the first end 421 of the second diode D2. The third end 413 of the first diode D1 is coupled to the first end 411 of the first diode D1 and the storage capacitor Cs2 and the liquid crystal capacitor Clc2 of the second sub-pixel unit 32. The third end 423 of the second diode D2 is coupled to the first end 421 of the second diode D2 and the storage capacitor Cs1 and the liquid crystal capacitor Clc1 of the first sub-pixel unit 31. As a result, in the bi-directional diode 40, a first parasitic capacitor Cgs1 is formed between the second end 412 and the third end 413 of the first diode D1; a second parasitic capacitor Cgs2 is formed between the second end 422 and the third end 423 of the second diode D2.

In this embodiment, the parasitic capacitors Cgs1 and Cgs2 of the bi-directional diode 40 may be coupled to the first sub-pixel electrode 22 and the second sub-pixel electrode 24 by electric connection between the bi-directional diode 40 and the first sub-pixel electrode 22 and electric connection between the bi-directional diode 40 and the second sub-pixel electrode 24. When the scan line G(n) is enabled by providing a scan signal thereto, the first sub-pixel electrode 22 and the second sub-pixel electrode 24 are charged by image data so that voltage difference is formed between the first sub-pixel electrode 22 and the second sub-pixel electrode 24. When the scan line G(n) is disabled by providing no scan signal, the voltage difference between the first sub-pixel electrode 22 and the second sub-pixel electrode 24 may be neutralized by the bi-directional diode 40 which forms a discharge path for the second sub-pixel electrode 24 to discharge. Accordingly, problem of image-sticking may be improved. Furthermore, the design of this embodiment may have an advantage that the second sub-pixel electrode 24 is less likely to be subject to influence of feed-through issue.

In addition, according to the design of this embodiment, the size or the width/length ratio of the first and second diodes D1 and D2 or the capacitance of the parasitic capacitors Cgs1 and Cgs2 can be adjusted so that the discharge speed of the bi-directional diode 40 is equal to the off current Ioff of the first thin film transistor T1. Accordingly, the problem of flicker may be efficiently improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A pixel unit coupled to a data line, a first scan line and a second scan line, the pixel unit comprising:
a first sub-pixel unit, comprising:
a first switching device coupled to the data line; and
a first storage capacitor and a first liquid crystal capacitor coupled to the first switching device; and
a second sub-pixel unit, comprising:
a second switching device coupled to the first switching device;
a coupling capacitor; and
a second storage capacitor and a second liquid crystal capacitor coupled to the second switching device;
wherein the coupling capacitor is coupled between a first input/output terminal and a second input/output terminal of the second switching device, a control terminal of the first switching device is coupled to the first scan line, and a control terminal of the second switching device is coupled to the second scan line that is adjacent to the first scan line.

2. The pixel unit according to claim 1, wherein the first switching device is formed by a first thin film transistor, the second switching device is formed by a second thin film transistor, and the coupling capacitor is coupled to the source and the drain of the second switching device.

3. The pixel unit according to claim 2, wherein the source of the first thin film transistor is coupled to the data line, and the drain of the first thin film transistor is coupled to the source of the second thin film transistor.

4. The pixel unit according to claim 3, wherein the first liquid crystal capacitor is formed by a first sub-pixel electrode and a common electrode that are spaced apart from each other by a liquid crystal layer, and the second liquid crystal capacitor is formed by a second sub-pixel electrode and the common electrode that are spaced apart from each other by the liquid crystal layer.

5. A liquid crystal display, comprising
a plurality of scan lines and a plurality of data lines together defining a plurality of pixel units, wherein each pixel unit comprises:
a first sub-pixel unit, comprising:
a first switching device coupled to one of the data lines; and
a first storage capacitor and a first liquid crystal capacitor coupled to the first switching device; and
a second sub-pixel unit, comprising:
a second switching device coupled to the first switching device;
a coupling capacitor;
a second storage capacitor and a second liquid crystal capacitor coupled to the second switching device, wherein the coupling capacitor is coupled between a first input/output terminal and a second input/output terminal of the second switching device, a control terminal of the first switching device is coupled to an n^{th} scan line where n is a positive integer larger than one, and a control terminal of the second switching device is coupled to an (n-1)^{th} scan line.

6. The liquid crystal display according to claim 5, wherein the first switching device is formed by a first thin film transistor, the second switching device is formed by a second thin film transistor, and the coupling capacitor is coupled to the source and the drain of the second switching device.

7. The liquid crystal display according to claim 6, wherein the source of the first thin film transistor is coupled to the data line, and the drain of the first thin film transistor is coupled to the source of the second thin film transistor.

8. The liquid crystal display according to claim 7, wherein the first liquid crystal capacitor is formed by a first sub-pixel electrode and a common electrode that are spaced apart from each other by a liquid crystal layer, and the second liquid crystal capacitor is formed by a second sub-pixel electrode and the common electrode that are spaced apart from each other by the liquid crystal layer.

9. A pixel unit, comprising:
a first sub-pixel unit, comprising:
a first switching device; and
a first storage capacitor and a first liquid crystal capacitor coupled to the first switching device;
a second sub-pixel unit, comprising:
a second storage capacitor and a second liquid crystal capacitor coupled to each other; and
a bi-directional diode coupled between the first liquid crystal capacitor and the second liquid crystal capacitor.

10. The pixel unit according to claim 9, wherein the bi-directional diode includes a first diode and a second diode, a first end of the first diode is coupled to a second end of the second diode, a second end of the first diode is coupled to a first end of the second diode, a third end of the first diode is coupled to a first end of the first diode, a third end of the second diode is coupled to a first end of the second diode, whereby a first parasitic capacitor is formed between the second end and the third end of the first diode and a second parasitic capacitor is formed between the second end and the third end of the second diode.

11. The pixel unit according to claim 10, wherein the third end of the first diode is coupled to the second storage capacitor and the second liquid crystal capacitor of the second sub-pixel unit, and the third end of the second diode is coupled to the first storage capacitor and the first liquid crystal capacitor of the first sub-pixel unit.

12. The pixel unit according to claim 11, wherein the first liquid crystal capacitor is formed by a first sub-pixel electrode and a common electrode that are spaced apart from each other by a liquid crystal layer, and the second liquid crystal capacitor is formed by a second sub-pixel electrode and the common electrode that are spaced apart from each other by the liquid crystal layer.

13. The pixel unit according to claim 9, wherein the first switching device is formed by a thin film transistor.

14. The pixel unit according to claim 13, wherein the discharge speed of the bi-directional diode is substantially equal to the off current of the first thin film transistor.
